(19) United States
(12) Patent Application Publication
(10) Pub. No.: US 2010/0030742 A1
(43) Pub. Date: Feb. 4, 2010

(54) SYSTEM AND METHOD FOR CAPTURING, STORING, RETRIEVING, AND PUBLISHING DATA

(76) Inventors: John Steven Surmont, Chula Vista, CA (US); Thomas A. Frasher, Sunnyvale, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/182,861

(22) Filed: Jul. 30, 2008

(51) Int. Cl. G06F 17/30

(52) U.S. Cl. 707/3; 707/100; 707/E17.009; 707/E17.014

(57) ABSTRACT

According to various embodiments of the invention, systems and methods are provided for capturing and storing aggregated and non-aggregated data within frames and for retrieval of such frames. Other embodiments of the invention involve systems and methods for publishing frame data to targeted data receivers, wherein the term “frame” refers generally to a collection of data objects and metadata that provides information relating to the data objects. The data objects may include, but are not limited to, images, video, audio, and text.

### TECHNICAL FIELD

The present invention relates to technology for capturing data, and more particularly, some embodiments relate to systems and methods for capturing data and related metadata for storage, retrieval, and publishing. This technology also allows for the attachment and/or correlation of other relevant metadata to the captured data. By way of example, additional metadata may be added to the frame, the data of the frame may be edited, and data may be deleted from the frame thereby creating a new frame.

### DESCRIPTION OF THE RELATED ART

Conventional technology for capturing data includes systems and methods for selecting, arranging, adapting, substituting, supplementing, and optimizing content for mobile and/or other electronic devices. Mobilized content may be accessible from any web-enabled electronic device including mobile phones and game devices as well as desktops and laptops. Mobilized content may further include media files such as images, audio, and videos as well as media clips of these files. However, such systems and methods fail to provide means for capturing and storing aggregated and non-aggregated data within frames, for retrieval of such frames, and for publishing frame data to targeted data receivers.

### BRIEF SUMMARY OF EMBODIMENTS OF THE INVENTION

According to various embodiments of the invention, systems and methods are provided for capturing and storing aggregated and non-aggregated data within frames and for retrieval of such frames. According to other embodiments of the invention, systems and methods are provided for publishing frame data to targeted data receivers. As used herein, the term “frame” refers generally to a collection of data objects combined with metadata that provides information relating to the data objects. The data objects may include, but are not limited to, images, video, audio, and text. In one embodiment, the invention practices a method comprising capturing several data objects, collecting the data objects, capturing metadata information regarding the data objects collected, and then generating the aforementioned frame using the data objects collected in conjunction with the metadata that describes the data objects. The metadata may include information including, but are not limited to, location data pertaining to where the data objects were captured, and time data pertaining to the local time of the capture location. In some embodiments, such metadata information originates from the capture device. In yet other embodiments, such metadata information can be captured separately at the location of frame generation and added to the frame either contemporaneously, or at a later time.

Usually, the data objects are captured by at least one capture device. Examples of capture devices used in accordance with the invention include, but are not limited to, cellular telephones, personal digital assistants, cameras, portable computers, desktop computers, server computers, and virtual machines. Subsequently, the frame is stored within a data store (such as a database) for future retrieval.

In further embodiments, the invention practices a method comprising at least one data requester querying the aforementioned data store for a single frame or for multiple frames that meet selected criteria. For example, in some instances of the invention, the criteria are satisfied when information contained within a frame's metadata matches the criteria. Suitable data requesters used in accordance with the invention include, but are not limited to, cellular telephones, cameras, personal digital assistants, portable computers, desktop computers, server computers, and virtual machines. The method further comprises retrieving from the data store the frame or frames that result from the query and, then, subsequently delivering the frame or frames to the data requester. In the case of multiple frames, the method further comprises (i) aggregating the multiple frames into a frame mosaic such that the multiple frames are related to each other, and (ii) ordering the frames within the frame mosaic according to a specified order. For example, where the frames are ordered according to their relevance to the search criteria, the less relevant frames may be ordered higher while the more relevant frames are ordered lower, or vice versa.

Some embodiments of the invention involve a method for publishing data objects to at least one targeted data receiver. Similar, to the method for retrieving data objects, such embodiments involve submitting a query based on specific criteria to a data store, retrieving a single frame or multiple frames from the data store, aggregating multiple frames that are related into a frame mosaic, and ordering the multiple frames within a frame mosaic into a specified order. Such embodiments further comprise pushing the single frame or frame mosaic to at least one targeted data receiver. Examples of targeted data receivers include, but are not limited to, cellular telephones, personal digital assistants, cameras, portable computers, desktop computers, server computers, and virtual machines. In yet other embodiments, wherein the a frame publisher pushes the frame or frames to the targeted data receiver, according to the invention the targeted data receiver can refresh the frame or frames that were pushed to it by pulling updated frames from the frame publisher when updates exist.

In further embodiments, the data requester or the targeted data receiver comprises a frame viewer that is capable of opening, viewing, or playing the data objects contained within the single frame or multiple frames. Examples of data objects within the frame or frames include, but are not limited to, images, video, audio, and text. Frames can also be part of the data objects within a frame. In yet further embodiments, the single frame or the frame mosaic contains an auditing survey, allowing a data requester or targeted data receiver to respond to one or more inquiries (contained within the auditing survey) regarding usage of the frames by the data requester or targeted data receiver. Subsequently, the completed auditing survey is returned to the data processor or frame publisher from which the single frame or frame mosaic originated.

In other embodiments, a system similar for capturing and storing data objects is provided. The system comprises a data processing system with a data store, and at least one data capture system, wherein the data capture system captures the data objects and the data processing system collects the data objects captured, captures metadata relating to the data objects captured, generates a frame from both the data objects and the metadata, and stores the frame in the data store. Various embodiments of this system practice features similar to those described in the methods above.

In yet another embodiment, a system similar for retrieval of data objects is provided. Specifically, the system comprises a data processing system with a data store, and at least one data retrieval system, wherein the data retrieval system submits a criteria based query to the data store and the data processing system retrieves the frames that match the criteria, aggregates the multiple frames that are related into a frame mosaic, orders the frames within the frame mosaic, and delivers the frame or frame mosaic to the data retrieval system from which the query originated. Various embodiments of this system practice features similar to those described in the methods above.

In another embodiment, a system for publishing data objects is provided. This system comprises a data processing system with a data store, a frame publishing system comprised within the data processing system, and at least one data receiving system, wherein the frame publishing system submits a criteria based query to the data store, the frame publishing system retrieves the frames that match the criteria, aggregates the multiple frames that are related into a frame mosaic, orders the frames within the frame mosaic, and pushes the frame or frame mosaic to the data receiving system. In some embodiments, the single frame or the frame mosaic is only pushed to a selected group of data receiving systems. Various embodiments of this system practice features similar to those described in the methods above.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a diagram illustrating one example of components utilized by a data processing system and a data capture system in accordance with the invention.

FIG. 2 is a diagram illustrating one example of components utilized by a data processing system, and either a data retrieval system or a data receiving system, in accordance with the invention.

FIG. 3 is a diagram illustrating an example system for capturing, storing, and retrieving data objects in accordance with the invention.

FIG. 4 is a diagram illustrating an example system for capturing and publishing data objects in accordance with the invention.

FIG. 5 is a diagram illustrating examples of devices that can practice the systems and methods in accordance with the invention.

FIG. 6 is flowchart illustrating an example method for capturing data objects in accordance with the invention.

FIG. 7 is flowchart illustrating an example method for retrieving data objects in accordance with the invention.

FIG. 8 is flowchart illustrating an example method for publishing data objects in accordance with the invention.

FIG. 9 is a simplified block diagram illustrating an example-computing module in accordance with one embodiment of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The embodiments of the present invention relate to technology for capturing data, and more particularly, some embodiments are directed towards systems and methods for capturing data and related metadata for storage, retrieval, and publishing. Some embodiments of the invention involve systems and methods for capturing and storing aggregated and non-aggregated data within frames and for subsequent retrieval of such frames. According to further embodiments of the invention, systems and methods for publishing frame data to targeted data receivers are provided. The technology of the invention also allows for the attachment and/or correlation of other relevant metadata to the captured data. By way of example, additional metadata may be added to the frame, the data of the frame may be edited, and data may be deleted from the frame thereby creating a new frame.

As used herein, the term “frame” refers generally to a collection of data objects and metadata that provides information relating to the data objects. A frame comprises both the data objects collected and the accompanying metadata collected regarding those data objects. Examples for data objects include, but are not limited to, images, video, audio, and text. Frames can also be part of the data objects within a frame. By way of example, the information stored in metadata may comprise location data relating to the capture of data objects, and/or the local time at a location when the data objects were captured.

Eventually, a collection of frames can be aggregated into what is referred to herein as a “frame mosaic.” In particular, frames that are related to one another by one or more of their respective data objects or metadata objects may be aggregated into such a unit. Further, once aggregated, the frames within the frame mosaic can be ordered based on selected criteria. Examples of frame ordering criteria include, but are not limited to, ordering based on the criterion used for aggregation, ordering based on frames of interest, ordering based on the number of frames within a specific frame mosaic, and ordering based on desired order of presentation. This also includes the common example of ordering the frames according to a frame's relevance to the initial search criteria, whereby the less relevant frames are numbered higher and more relevant frames are numbered lower.

FIG. 1 is a diagram illustrating one example of components utilized by a data processing system in accordance with the invention. In some embodiments, a data processing system is responsible for collecting data objects that are captured by one or more data capturing systems. FIG. 1 illustrates a data capture component 110 and location tracking component 120. The capture component 110 is used to capture data of interest and send it to a data collector component 130. Examples of such data include, but are not limited to, photographic data, measurement data (e.g. temperature, salinity, barometric pressure, other environmental data), count data, text data (e.g. speech-to-text), audio data, and video data. The captured data can be aggregated together before being sent to the data collector component 130, or the captured data can be sent in a non-aggregated fashion.

Data collector component 130 is further responsible for collecting metadata regarding the captured data collected. For some embodiments of the invention that entail use of a location tracking component 120, location metadata is also provided to the collector component 130. The location metadata can describe the geographic location from which the captured data originated. In some instances, the tracking component 120 provides location metadata in the form of latitude and longitude data, which accompanies the captured data. Local time is another example of metadata provided to component 130 as it accompanies the captured data. Furthermore, in some embodiments, data collector component 130 can self-generate metadata relating to the captured data as the data is collected from the data capture component 110.

Data collector component 110 subsequently passes on the captured data and its related metadata to a frame generator 135, which generates a frame from their combination and stores the frame within a data store 140. The frame encapsulates related data objects with the metadata that describes those related data objects.

The data store 140 functions to store frames while allowing for cross links between data objects. A suitable data store is a database (such as Oracle®, MySQL®, Microsoft® Access) which employs a database schema allowing for cross links. Such a database could reside on a system set up to run database server software, including, but not limited to, laptop computers, desktop computers, servers, and any purpose-built device capable of executing the host database instructions. The data can also be stored on an external storage system, such as a PAR3 or equivalent high capacity storage system.

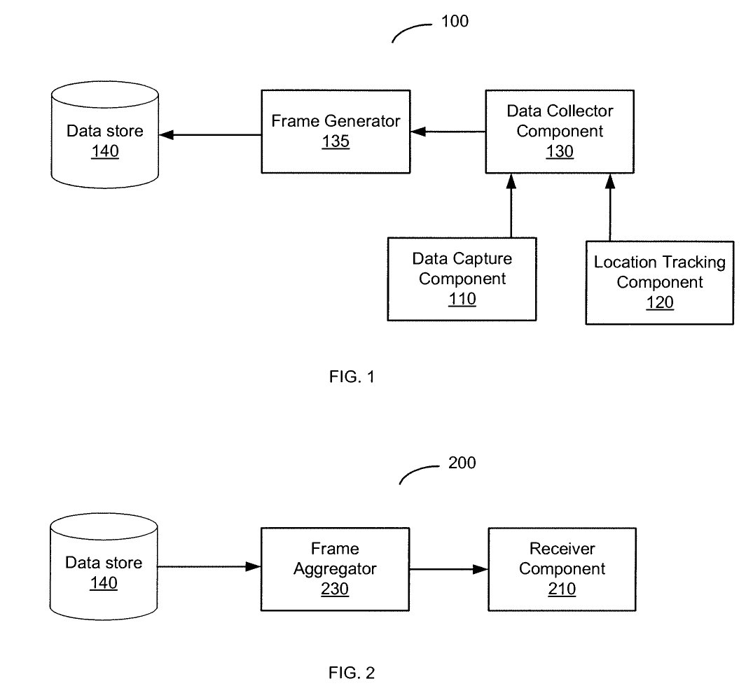

FIG. 2 is a diagram illustrating one example of components utilized in accordance with the invention by a data processing system and either a data retrieval system or a data receiving system. The frame aggregator 230 is responsible for retrieving and collecting the frame or frames that result from a criteria based query submitted to data store 140. In this example, if one frame results from the query, aggregator 230 passes it on to a receiver component 210 for usage. In the alternative, if the frame aggregator 230 encounters multiple frames as a result of the query, those frames are aggregated into a frame mosaic, which is then passed on to the receiver component 210 for usage. The receiver component 210, in turn, is capable of opening, viewing, or playing both a single frame and multiple frames encapsulated within a frame mosaic.

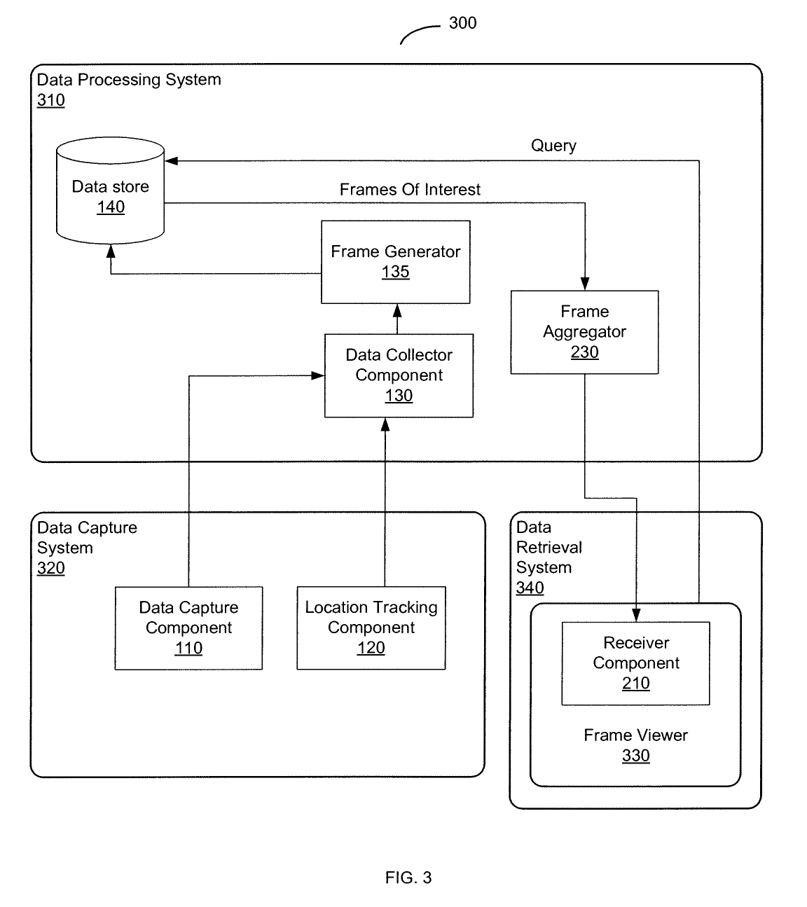

FIG. 3 is a diagram illustrating an example system for capturing, storing, and retrieving data objects in accordance with the invention. This embodiment of the invention utilizes the example components illustrated in FIG. 1 and FIG. 2. Specifically, (i) data processing system 310 comprises the aforementioned data store 140, frame generator 135, data collector 130, and frame aggregator 230; (ii) data capture system 320 comprises the aforementioned data capture component 110 and location tracking component 120; and (iii) data retrieval system 340 comprises the aforementioned receiver component 210. Certain embodiments of the invention are capable of implementing all three systems (data processing, data capture, and data retrieving) into one unit or device. Alternatively, some embodiments of the invention implement the data capture system 320 and data retrieval system 340 in one unit or device, while the data processing system 310 is implemented in another unit or device.

Embodiments of data capture system 320 can reside on one or more data capture devices, all of which are capable of capturing data and sending it to data processing system 310. Examples of data capture devices include, but are not limited to, commercial off the shelf (COTS) devices, cellular telephones, cameras, personal digital systems (PDAs), portable computers, desktop computers, server computers, and virtual machines. Additionally, embodiments of data processing system (310) are capable of being instructed on the conditions and locations for acquisition of data. This allows for data processing system 310 to capture and store data objects from data capture system 320 only when specified conditions (e.g. location, temperatures, altitude, etc.) are all satisfied.

In some embodiments, such as system 300, the receiver component 210 is part of a framer viewer 330, which may reside on data retrieval system 340 as either a software implementation or hardware implementation. Examples of devices used in the data retrieval system 340 include, but are not limit to, cellular telephones, cameras, personal digital systems (PDAs), portable computers, desktop computers, server computers, and virtual machines. The frame viewer is capable of opening, viewing, and playing frames and frame mosaics it receives from data processing system 310. In further embodiments, the frame viewer allows the data processing system 310 to be agnostic to the type of device that is receiving the frames; the frame viewer can be specific to device platform so the data processing system 310 can function uniformly for all devices.

In particular embodiments, the frame viewer 330 submits a query to the data processing system for desired data. The query is passed on to data store 140, which results in one or more frames being retrieved by frame aggregator 230. The frame aggregator 230 either aggregates multiple frames into a frame mosaic and passes it on to data retrieval system 340, or receives a single frame and passes it on to data retrieval system 340. This provides data retrieval system 340 the flexibility to request either a single frame or multiple frames (in the form of a frame mosaic). In embodiments where data store 140 is implemented as a database, the query can be based on Structured Query Language (SQL) or some other query language.

In further embodiments of the invention, an audit survey is attached to the frame or frame mosaic sent to data retrieval system 340. The auditing survey allows data processing system 310 to survey factors of frame usage by the receiving unit or device. Such factors include, but are not limited to, time taken to review data objects contained within the frames and verification of proper usage of data objects.

In an example embodiment for retrieving data objects, a set of images for a geographic area is requested based on latitude and longitude. Frames with specific coordinates can be requested from a database using the desired coordinates as the search term. If multiple frames are located matching the desired coordinates, such frames are aggregated into a frame mosaic, with the headers of the frame mosaic containing the frame number for the frame viewer to start with, and the order to arrange the frame mosaic for best presentation.

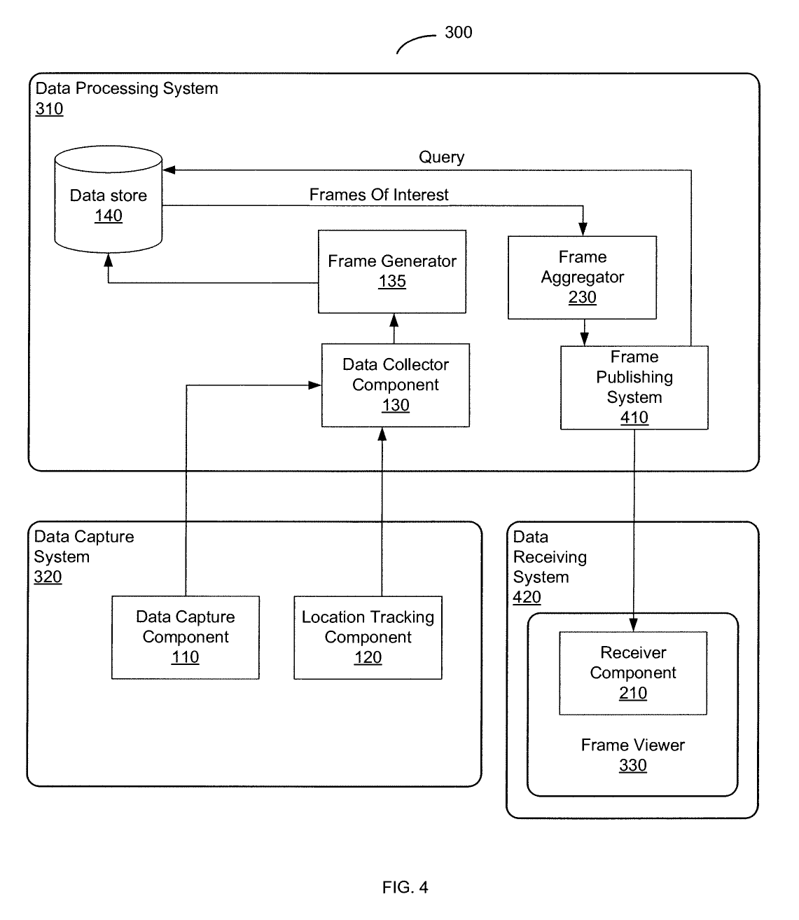

FIG. 4 is a diagram illustrating an example system for capturing and publishing data objects in accordance with the invention. Like the system of FIG. 3, this example system comprises a data processing system 310 and one or more data capture systems 320. However, unlike the system of FIG. 3, the data processing system further comprises a frame publishing system 410. In this example embodiment, frame publishing system 410 allows for distribution of a single frame or a frame mosaic to one or more data receiving systems 420. When frames of specific interest are desired to be published to one or more data receiving systems 420, the frame publishing system 410 is initiated to submit a query to data store 140 based on the specific interest, resulting in one or more frames being located within data store 140.

As described above, frame aggregator 230 retrieves one or more frames and, in the case of multiple frames, aggregates the frames into a frame mosaic. The resulting frame or frames are subsequently sent to frame publishing system 410, which pushes them onto data receiving systems that have been specifically targeted.

As used herein, the term “push” refers to sending data to a target without a request by the target. In various embodiments of the invention, examples of data receiving systems include, but are not limited to, cellular telephones, cameras, personal digital systems (PDAs), portable computers, desktop computers, server computers, and virtual machines. Similar to the system of FIG. 3, a frame viewer 320 on data receiving system 420 may be utilized to open, view, and play frames that are pushed to it by frame publishing system 410. Additionally, data receiving system 420 can subsequently perform a refresh operation by pulling updated frames from the publishing system 410.

By way of example, frames may be published by, (i) publishing the frames to a web page hosted by a webserver, (ii) immediately pushing frames to a mobile device (e.g. cellular telephone, smartphone, etc.), or (iii) pushing frames to one or more computers connected to a Wide Area Network (WAN). Additionally, the implementation of a Frame Simple Syndication (FSS) system in some embodiments would enable and simplify subscription to the frame publishing system 410 by one or more data receiving systems 420.

An example embodiment of a publishing system involves publishing to a large group of Emergency Medical Technicians (EMTs), wherein a frame or frames containing an instructional class for emergency medical technician training is pushed to the EMTs. The frame or multiple frames (in the form of a frame mosaic) is retrieved from the database, placed in the order of instruction, and then pushed to the device addresses specified by the requester of the frame publication. The requester may be automatic or manually initiated. Optionally, these instruction frames may be reordered and republished to the target devices. Additionally, the target devices may pull updated instruction frames as a refresh operation. Also, the publishing request may also come from the remote device client, requesting that the frame or frames be pushed to the device for viewing.

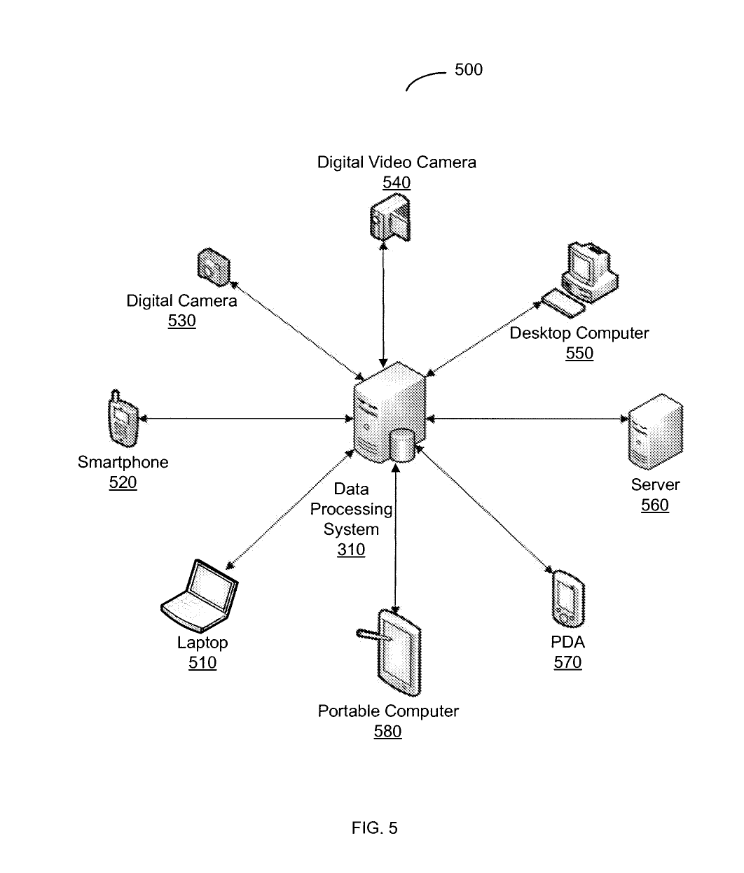

FIG. 5 is a diagram illustrating examples of devices that can practice the systems and methods in accordance with the invention. In particular, devices 510, 520, 530, 540, 550, 560, 570 580 may be employed for implementation of one or more of the embodiments of the invention (e.g., data capture system 310, data retrieval system 340, or data receiving system 420). In addition, all of these devices are capable of communicating with the data processing system 310, over various forms of communication channels (Internet, LAN, WAN, wireless, radio, etc.). For example a smartphone 520, such as a Blackberry®, is capable of relaying data objects to data processing system 310 via e-mail over the Internet. Subsequently, frame publishing system 410 pushes frames to the device via e-mail (which in some embodiments can be opened, viewed, or played by a frame viewer residing on the Blackberry® device).

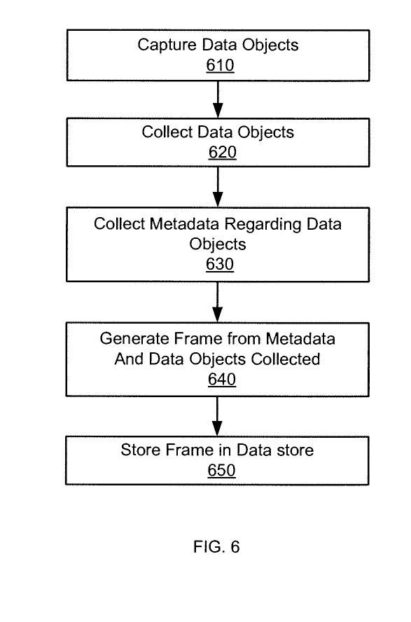

Referring now to FIG. 6, the flowchart illustrates an example method for capturing data objects in accordance with the invention. Specifically, the method involves (i) capturing data objects at 610, (ii) collecting the data objects at 620, (iii) collecting metadata regarding the data objects 630, and (iv) generating a frame from the metadata and data objects collected. Subsequently, the frame is stored in a data store at 650. The data store is capable of storing and retrieving metadata, data objects, and cross links between data objects. In particular embodiments, the method can be performed by a system configured similar to that of FIG. 3.

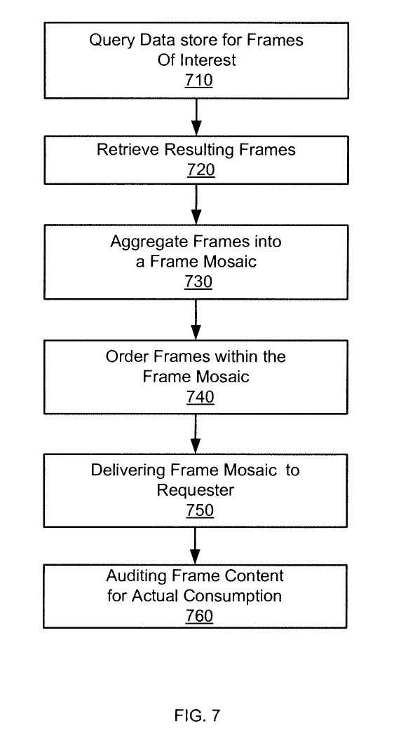

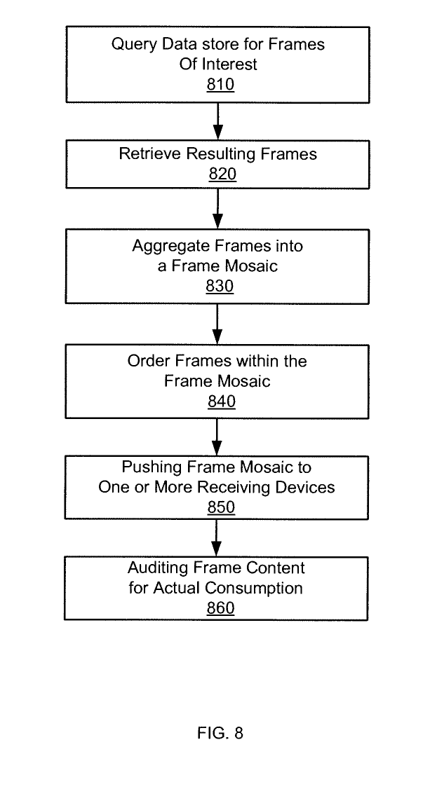

FIG. 7 is flowchart illustrating an example method for retrieving data objects in accordance with the invention. In various embodiments, this method can work in conjunction with the method of FIG. 6 (and FIG. 8). At 710 a data store 140 is queried by a data requester for frames desired to be retrieved (frames of interest), followed by retrieval of the frame or frames that result from the query at 720. In the case of multiple frames, they are aggregated and ordered into a frame mosaic at operations 730 and 740, respectively. In the following operation 750, the frame or frame mosaic is delivered to the data requester. Optionally, some embodiments have an auditing survey attached to the frames, allowing auditing of frame content for actual usage (consumption) at 760. Similar to the method of FIG. 6, in specific embodiments, the method of FIG. 7 can be performed by a system configured similar to of FIG. 3.

FIG. 8 is flowchart illustrating an example method for publishing data objects in accordance with the invention. This method may be employed in conjunction with the methods described in FIG. 6 and FIG. 7. In operation 810, data store 140 is queried (usually by a frame publisher) for frames desired to be published (frames of interest), and then the frame or frames that result from the query are retrieved at 820. Multiple frames may be aggregated and ordered into a frame mosaic at operations 830 and 840, respectively. In operation 850, the frame or frame mosaic is pushed to one or more receiving devices. Some embodiments include an auditing survey attached to the frames, allowing auditing of frame content for actual usage (consumption) at 860. In specific embodiments, the method of FIG. 8 can be performed by a system configured similar to that of FIG. 4.

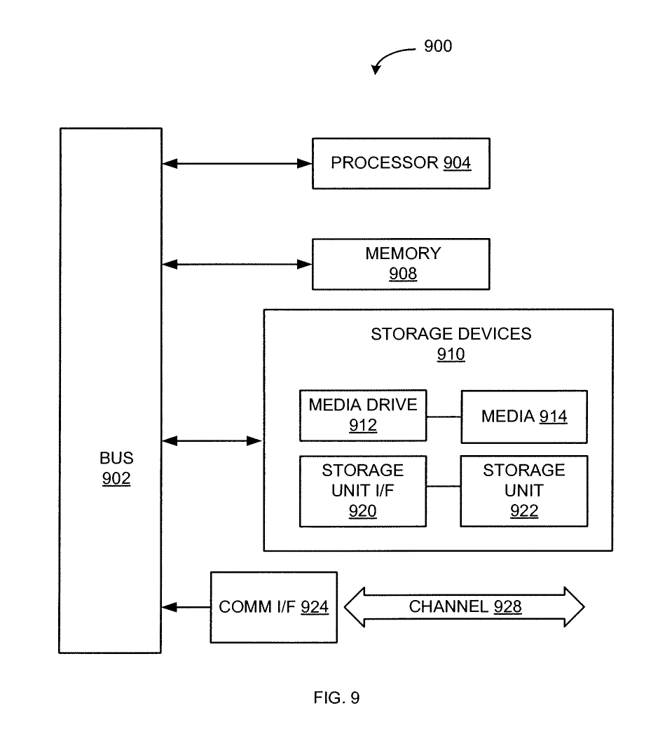

In regards to FIG. 9, computing module 900 may represent, for example, (i) computing or processing capabilities found within desktop, laptop and notebook computers; (ii) mainframes, supercomputers, workstations or servers; or (iii) any other type of special-purpose or general-purpose computing devices as may be desirable or appropriate for a given application or environment. Computing module 900 might also represent computing capabilities embedded within or otherwise available to a given device. For example, a computing module might be found in other electronic devices. Computing module 900 might include, for example, one or more processors or processing devices, such as a processor 904. Processor 904 might be implemented using a general-purpose or special-purpose processing engine such as, for example, a microprocessor, controller, or other control logic. In the example illustrated in FIG. 9, processor 904 is connected to a bus 903 or other communication medium to facilitate interaction with other components of computing module 900.

Computing module 900 might also include one or more memory modules, referred to as main memory 908. For example, random access memory (RAM) or other dynamic memory might be used for storing information and instructions to be executed by processor 904. Main memory 908 might also be used for storing temporary variables or other intermediate information during execution of instructions to be executed by processor 904. Computing module 900 might further include a read only memory (“ROM”) or other static storage device coupled to bus 903 for storing static information and instructions for processor 904.

The computing module 900 may also include one or more various forms of information storage mechanism 910 such as a media drive 912 and a storage unit interface 920. The media drive 912 might include a drive or other mechanism to support fixed or removable storage media 914 such as a hard disk drive, a floppy disk drive, a magnetic tape drive, an optical disk drive, a CD or DVD drive (R or RW), or other removable or fixed media drive. Accordingly, storage media 914, might include, for example, a hard disk, a floppy disk, magnetic tape, cartridge, optical disk, a CD or DVD, or other fixed or removable medium that is read by, written to, or accessed by media drive 912. As these examples illustrate, the storage media 914 can include a computer usable storage medium having stored therein particular computer software or data.

In alternative embodiments, information storage mechanism 910 might include other similar instrumentalities for allowing computer programs or other instructions or data to be loaded into computing module 900. Such instrumentalities might include, for example, a fixed or removable storage unit 922 and an interface 920. Examples of such storage units 922 and interfaces 920 can include without limitation: (i) a program cartridge and cartridge interface, (ii) a removable memory (for example, a flash memory or other removable memory module) and memory slot, (iii) a PCMCIA slot and card, and (iv) other fixed or removable storage units 922 and interfaces 920 that allow software and data to be transferred from the storage unit 922 to computing module 900.

Computing module 900 might also include a communications interface 924. Communications interface 924 might be used to allow software and data to be transferred between computing module 900 and external devices. Examples of communications interface 924 might include a modem or softmodem, a network interface (such as an Ethernet, network interface card, WiMedia, 802.XX or other interface), a communications port (such as for example, a USB port, IR port, RS232 port Bluetooth interface, or other port), or other communications interface. Software and data transferred via communications interface 924 might typically be carried on signals, which can be electronic, electromagnetic, optical or other signals capable of being exchanged by a given communications interface 924. These signals might be provided to communications interface 924 via a channel 928. This channel 928 might carry signals and might be implemented using a wired or wireless medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 908, storage unit 920, media 914, and signals on channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 900 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the operations are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for capturing and storing data objects, comprising:
capturing a plurality of data objects;
collecting the data objects;
capturing metadata relating to the data objects;
generating a frame from the data objects and the metadata; and
storing the frame in a data store.

2. The method of claim 1, wherein the data objects include images, video, audio, and text.

3. The method of claim 1, wherein the metadata include a location data and a time data relating to the data objects within the frame.

4. The method of claim 3, wherein the location data or the time data originates from a capture device.

5. The method of claim 1, wherein at least one capture device performs the operation of capturing the plurality of data objects.

6. The method of claim 5, wherein the capture device is selected from the group consisting of: a cellular telephone, a personal digital assistant, a camera, a portable computer, a desktop computer, a server computer, and a virtual machine.

7. The method of claim 1, wherein the method is performed by a computer program product having computer readable program code functions embedded in a computer useable medium.

8. A method for retrieving data objects, comprising:
submitting a query to a data store, wherein the query originates from at least one data requester, the query is based on selected criteria, and the query results in one or more frames that meets the criteria;
retrieving the frames from the data store;
aggregating the frames into a frame mosaic, wherein the frames are related to one another;
ordering the frames within the frame mosaic; and
delivering the frame mosaic to the data requester.

9. The method of claim 8, wherein the frame mosaic comprises data objects, wherein the data objects include images, video, audio, and text.

10. The method of claim 8, wherein the data requester is selected from the group consisting of: a cellular telephone, a personal digital assistant, a camera, a portable computer, a desktop computer, a server computer, a virtual machine, and a data display device.

11. The method of claim 8, wherein the data requester comprises a frame viewer, wherein the frame viewer is capable of opening, viewing, or playing the data objects contained within the frame mosaic.

12. The method of claim 8, wherein an auditing survey is attached to the frame mosaic, a data processor delivers the single frame or the frame mosaic to the data requester, the data requester completes the auditing survey, and the data requester sends the auditing survey back to the data processor.

13. The method of claim 12, wherein the auditing survey comprises at least one inquiry regarding usage of the frame mosaic by the data requester.

14. The method of claim 8, wherein ordering the plurality of frames is based on relevance of the frames, wherein a less relevant frame is ordered higher and a more relevant frame is ordered lower, or wherein the less relevant frame is ordered lower and the more relevant frame is ordered higher.

15. The method of claim 8, wherein the method is performed by a computer program product having computer readable program code functions embedded in a computer useable medium.

16. A method for publishing data objects, comprising:
submitting a query to a data store, wherein the query is based on selected criteria and the query results in one or more frames that meets the criteria;
retrieving the frames from the data store;
aggregating the frames into a frame mosaic, wherein the plurality of frames are related to one another;
ordering the frames within the frame mosaic; and
pushing the frame mosaic to at least one targeted data receiver.

17. The method of claim 16, wherein the frame mosaic comprises data objects, wherein the data objects include images, video, audio, and text.

18. The method of claim 16, wherein the targeted data receiver is selected from the group consisting of: a cellular telephone, a camera, a personal digital assistant, a portable computer, a desktop computer, a server computer, and a virtual machine.

19. The method of claim 16, wherein a frame publisher pushes the frame mosaic to the targeted data receiver.

20. The method of claim 19, wherein the targeted data receiver refreshes the frame mosaic by pulling an updated frame mosaic from the frame publisher.

21. The method of claim 16, wherein an auditing survey is attached to the frame mosaic, a frame publisher pushes the frame mosaic to the targeted data receiver, the targeted data receiver completes the auditing survey, and the targeted data receiver sends the auditing survey back to the frame publisher.

22. The method of claim 21, wherein the auditing survey comprises at least one inquiry regarding usage of the frame mosaic by the targeted data receiver.

23. The method of claim 16, wherein pushing the frame mosaic involves pushing the frame mosaic to selected targeted data receivers.

24. The method of claim 16, wherein the targeted data receiver comprises a frame viewer, wherein the frame viewer is capable of opening, viewing, or playing the data objects contained within the frame mosaic.

25. The method of claim 16, wherein the method is performed by a computer program product having computer readable program code functions embedded in a computer useable medium.

26. A system for capturing and storing data objects, comprising:
at least one data capture system;
a data store;
a data processing system, wherein the data processing system comprises the data store;
wherein the data capture system performs the operation of capturing a plurality of data objects; and
wherein the data processing system performs the operations of
collecting the data objects,
capturing a plurality of metadata relating to the data objects,
generating a frame from the data objects and the metadata, and
storing the frame in the data store.

27. The system of claim 26, wherein the data objects include images, video, audio, and text.

28. The system of claim 26, wherein the metadata include a location data and a time data relating to the data objects within the frame.

29. The system of claim 28, wherein the location data and the time data are provided by the data capture system.

30. The system of claim 26, wherein the data capture system is selected from the group consisting of: a cellular telephone, a camera, a personal digital assistant, a portable computer, a desktop computer, a server computer, a virtual machine, and another capture device.

31. A system for retrieving data objects, comprising:
at least one data retrieval system;
a data store;
a data processing system, wherein the data processing system comprises the data store;
wherein the data retrieval system performs the operations of submitting a query to the data store, the query is based on criteria, and the query results in one or more frames that meet the criteria; and
wherein the data processing system performs the operations of:
retrieving the frames from the data store;
aggregating the frames into a frame mosaic, wherein the plurality of frames are related to one another;
ordering the frames within the frame mosaic; and
delivering the frame mosaic to the data retrieval system.

32. The system of claim 31, wherein the frame mosaic comprises a plurality of data objects and the data objects include images, video, audio, and text.

33. The system of claim 31, wherein the data retrieval system is selected from the group consisting of: a cellular telephone, a personal digital assistant, a camera, a portable computer, a desktop computer, a server computer, a virtual machine, and a data display device.

34. The system of claim 31, wherein the data retrieval system comprises a frame viewer, wherein the frame viewer is capable of opening, viewing, or playing the data objects contained within the frame mosaic.

35. The system of claim 31, wherein an auditing survey is attached to the frame mosaic, the data retrieval system completes the auditing survey, and the data retrieval system sends the auditing survey back to the data processing system.

36. The system of claim 35, wherein the auditing survey comprises at least one inquiry regarding usage of the frame mosaic by the data retrieval system.

37. The system of claim 31, wherein ordering the plurality of frames is based on relevance of the frames, wherein a less relevant frame is ordered higher and a more relevant frame is ordered lower, or wherein the less relevant frame is ordered lower and the more relevant frame is ordered higher.

38. The system for publishing data objects, comprising:
a least one data receiving system;
a data store;
a frame publishing system;
a data processing system, wherein the data processing system comprises the data store and data receiving system; and
wherein the frame publishing system performs the operations of:
submitting a query to the data store, wherein the query is based on a criteria and the query results in one or more frames that meets the criteria,
retrieving the frames from the data store;
aggregating the frames into a frame mosaic, wherein the plurality of frames are related to one another;
ordering the frames within the frame mosaic; and
pushing the frame mosaic to at least one data receiving system.

39. The system of claim 38, wherein the frame mosaic comprises a plurality of data objects and the data objects include images, video, audio, and text.

40. The system of claim 38, wherein the data receiving system is selected from the group consisting of: a cellular telephone, a personal digital assistant, a camera, a portable computer, a desktop computer, a server computer, a virtual machine, and another capture device.

41. The system of claim 38, wherein the data receiving system refreshes the frame mosaic by pulling an updated frame mosaic from the frame publishing system.

42. The system of claim 38, wherein an auditing survey is attached to the frame mosaic, the data receiving system completes the auditing survey, and the data receiving system sends the auditing survey back to the frame publishing system.

43. The system of claim 42, wherein the auditing survey comprises at least one inquiry regarding usage of the frame mosaic by the data receiving systems.

44. The system of claim 38, wherein pushing the frame mosaic involves pushing only to selected data receiving systems.

45. The system of claim 38, wherein the data receiving system comprises a frame viewer capable of opening, viewing, or playing the data objects contained within frame mosaic.
